(19) United States
(12) Patent Application Publication
(10) Pub. No.: US 2004/0099132 A1
(43) Pub. Date: May 27, 2004

(54) Tactile metronome

(76) Inventor: Christopher V. Parsons, San Antonio, TX (US)

Correspondence Address: WAYNE J COLTON INC, THE MILAM BUILDING SUITE 1032, 115 EAST TRAVIS STREET, SAN ANTONIO, TX, 78205, US

(21) Appl. No.: 10/306,263

(22) Filed: Nov. 27, 2002

(51) Int. Cl. G10H 3/14

(52) U.S. Cl. 84/730

(57) ABSTRACT

A tactile metronome for use by a musician generally comprises a signal generator for producing an electrical signal according to a desired timing scheme and a tactile transducer in electrical communication with the signal generator. The tactile transducer, which may comprise a piezoelectric device, a buzzer, electrodes or any substantial equivalent, is adapted to impart a tactile sensation to the musician in response to the generated electrical signal. A strap, which may comprise an elastic material or a soft cloth material with hook and loop fasteners, is preferably provided to secure the tactile transducer in place on the musician's body.

### FIELD OF THE INVENTION

The present invention relates to music technology. More particularly, the invention relates to a metronome with provision for communication with a musician through tactile stimulation.

### BACKGROUND OF THE INVENTION

The metronome is well established as a fundamental tool of musical education. Having been developed before the advent of the electrical apparatus, the traditional metronome comprises a mechanical assembly adapted to generate a clicking sound at a desired beat frequency. With the advent of modern electronics a very precise audio output may now be produced or, as is particularly useful for the musical education of deaf persons, the output signal from the metronome may be communicated with a visual indicator such a flashing light.

While the improvements made possible through technology are meritorious, Applicant has discovered that the improvements generally serve only to better implement a fundamentally flawed method. In particular, Applicant has noted that the audio nature of the metronome, which is apparently a holdover from the days of primitive technology, is distracting to the musician and, in at least some musical environments, ineffective due to the inability of the musician to clearly hear the audio signal. Additionally, the audio signal is wholly inappropriate for use by the hearing impaired. While this latter issue has been at least addressed through metronomes with visual outputs, it is noted that the use of the visual indicator mandates that the musician completely memorizes his or her music.

It is therefore an overriding object of the present invention to improve over the prior art by providing a metronome that is free of the foregoing flaws. In particular, it is an object of the present invention to provide a metronome having a tactile output such that the musician may feel the desired beat regardless of the volume of the performance or a particular user's physical limitations. Additionally, it is an object of the present invention to provide such a metronome that also may be programmed to provide enhanced capabilities such as, for example, complex output rhythms and/or tactile stimulation designed for the development of intonation. Finally, it is an object of the present invention to provide such a metronome that is also economical to produce and easy to use.

### SUMMARY OF THE INVENTION

In accordance with the foregoing objects, the present invention—a tactile metronome for use by a musician—generally comprises a signal generator for producing an electrical signal according to a desired timing scheme and a tactile transducer in electrical communication with the signal generator. The tactile transducer, which may comprise a piezoelectric device, a buzzer, electrodes or any substantial equivalent, is adapted to impart a tactile sensation to the musician in response to the generated electrical signal. A strap, which may comprise an elastic material or a soft cloth material with hook and loop fasteners, is preferably provided to secure the tactile transducer in place on the musician's body.

In at least one embodiment, the signal generator is adapted to produce complex rhythms and may be programmable such that the musician may define the complex rhythm. In this embodiment, the signal generator preferably further comprises a micro-controller.

A display, such as a liquid crystal display or a light emitting diode display, is provided to facilitate selection of the desired output frequency or rhythmic pattern.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a functional block diagram, the preferred embodiment of the tactile metronome of the present invention; and

FIG. 2 shows, in a perspective view, the tactile metronome of FIG. 1 as operably employed by a musician.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

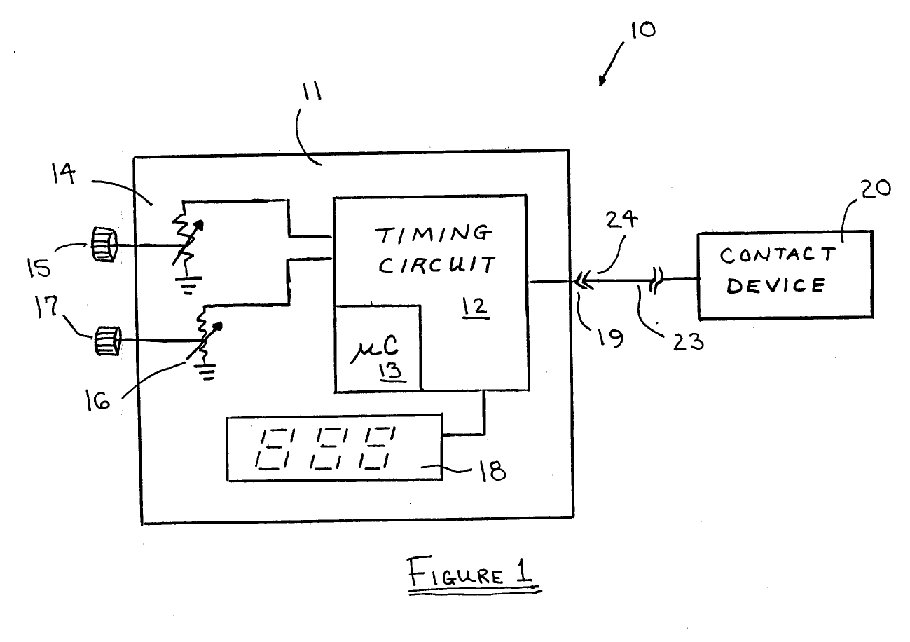

Referring now to the figures, the tactile metronome 10 of the present invention is shown to generally comprise a signal generator 11 in electrical communication with a contact device 20, which, as will be better understood further herein, is adapted to impart to a user a tactile stimulation. As particularly shown in FIG. 1, the signal generator 11 generally comprises a timing circuit 12, which may readily be implemented with a micro-controller 13 or other appropriate circuitry, and adjustment means 14, 16 for the various aspects of the timing circuit 12. A display 18, which may comprise a liquid crystal display, light emitting diode display or any other substantially equivalent structure, is also preferably provided on the signal generator 11 for use as will be better understood further herein.

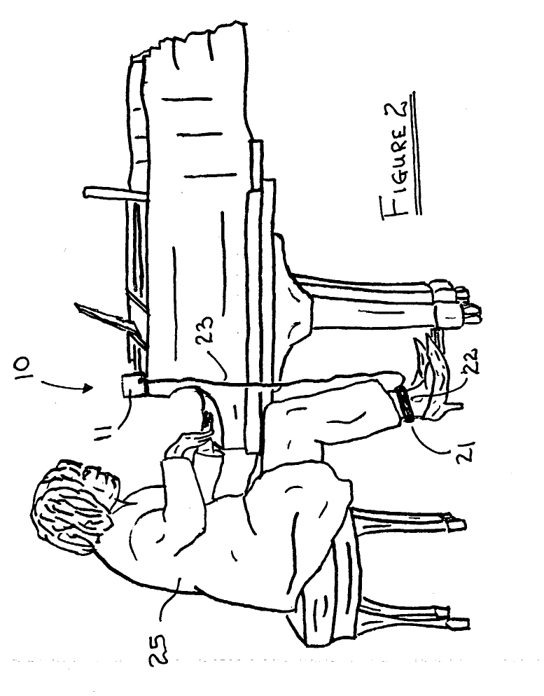

As shown in FIGS. 1 and 2, the contact device 20, which is adapted for wear on the user's ankle, wrist, chest or other appropriate location, generally comprises a strap 21 of soft cloth and/or elastic material having a tactile transducer 22 affixed to an interior side thereof. The strap 21 also preferably comprises releasably engageable hook and loop type fasteners, such as are commercially available under the well-known trademark “VELCRO,” or any other substantially equivalent fastener system, for snuggly securing the strap 21 about the user's ankle, wrist, chest or other location. In this manner, those of ordinary skill in the art will appreciate that the strap 21 is adapted to facilitate intimate contact between the tactile transducer 22, which may comprise a piezoelectric device, buzzer, pair of electrodes or any other substantially equivalent structure capable of imparting the desired tactile stimulation, and the user's body. Additionally, an electrical cable 23, which preferably terminates in a standard plug 24, provides electrical communication between the contact device 20 and an output jack 19 from the timing circuit 12 of the signal generator 11.

In use, as particularly shown in FIG. 2, a musician 25 affixes the tactile transducer 22 in a minimally obtrusive location utilizing the strap 21. The musician 25 then connects the electrical cable 23 between the contact device 20 and the signal generator 11 by inserting the standard plug 24 into the output jack 19 of the signal generator 11. An intensity adjustment knob 17 is then utilized to apply power to the timing circuit 12 through the intensity adjustment 16, which may simply comprise a potentiometer, variable resistor or any other substantially equivalent structure. Likewise, the musician 25 then utilizes a frequency adjustment knob 15 attached to frequency adjustment 14 to set the beats per minute to be generated by the signal generator 11. To this end, those of ordinary skill in the art will recognized that the display 18 should be adapted to provide a digital readout of the current setting. Finally, the musician 25 may perform his or her musical instrument of choice while literally feeling the desired beat without having to divert attention to listen to a traditional metronome or watch for flashing lights or the like.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, those of ordinary skill in the art will recognize, especially in light of this exemplary description, that a timing circuit 12 implemented about a micro-controller 13 may readily be programmed to provide complex beat patterns. In such an embodiment, a communication interface or other programming input as well as read only or non-volatile random access memory are provided for the signal generator 11 such that the musician 25 may input and/or select a desired beat pattern. Likewise, those of ordinary skill in the art will recognize that the tactile metronome 10 may also be programmed to generate audio frequency stimulation through the tactile transducer 22, thereby assisting the musician 25 in the development of intonation. In any case, because the scope of the present invention is much broader than any particular embodiment, the foregoing detailed description should not be construed as a limitation of the scope of the present invention, which is limited only by the claims appended hereto.

What is claimed is:

1. A tactile metronome for use by a musician, said tactile metronome comprising:
a signal generator for producing an electrical signal according to a desired timing scheme; and
a tactile transducer in electrical communication with said signal generator, said tactile transducer being adapted to impart a tactile sensation to the musician in response to said electrical signal.

2. The tactile metronome as recited in claim 1, wherein said tactile transducer comprises a piezoelectric device.

3. The tactile metronome as recited in claim 1, wherein said tactile transducer comprises a buzzer.

4. The tactile metronome as recited in claim 1, wherein said tactile transducer comprises electrodes.

5. The tactile metronome as recited in claim 1, said tactile metronome further comprising a strap, said strap being adapted to secure said tactile transducer in place on the musician's body.

6. The tactile metronome as recited in claim 5, wherein said strap comprises an elastic material.

7. The tactile metronome as recited in claim 5, wherein said strap comprises a soft cloth material.

8. The tactile metronome as recited in claim 7, wherein said strap further comprises hook and loop fasteners for securing one edge of said strap to another.

9. The tactile metronome as recited in claim 1, wherein said signal generator is adapted to produce complex rhythms.

10. The tactile metronome as recited in claim 9, wherein said signal generator is programmable such that the musician may define said complex rhythm.

11. The tactile metronome as recited in claim 10, wherein said signal generator further comprises a micro-controller.

12. The tactile metronome as recited in claim 1, wherein said signal generator further comprises a display.

13. The tactile metronome as recited in claim 12, wherein said display is adapted to provide information regarding said timing scheme.

14. The tactile metronome as recited in claim 13, wherein said information comprises frequency data.

15. The tactile metronome as recited in claim 12, wherein said display comprises a liquid crystal display.

16. The tactile metronome as recited in claim 12, wherein said display comprises a light emitting diode display.
